(19) United States
(12) Patent Application Publication
(10) Pub. No.: US 2003/0158626 A1
(43) Pub. Date: Aug. 21, 2003

(54) Method of storing test data in a fuel dispenser

(75) Inventors: William Goggin, Garrett, IN (US); William J. Myers, Fort Wayne, IN (US)

Correspondence Address: RANDALL J. KNUTH P.C., 3510-A STELLHORN ROAD, FORT WAYNE, IN, 46815-4631, US

(73) Assignee: Tokheim Corporation

(21) Appl. No.: 10/078,830

(22) Filed: Feb. 19, 2002

(51) Int. Cl. G06F 12/00

(52) U.S. Cl. 700/237

(57) ABSTRACT

A method and apparatus for storing test data in a fuel dispenser. The test data is generated for the fuel dispenser. The test data is then stored to a nonvolatile memory within the fuel dispenser.

### BACKGROUND OF THE INVENTION

1. Field of the Invention

The present invention relates to a method and apparatus for storing test data in a fuel dispenser. The test data is stored to a nonvolatile memory.

2. Description of the Related Art.

The testing of fuel dispensers is well known in the art. The results from the tests are typically sent to a printer and/or a display. One problem is that as the results of the testing of the fuel dispenser are printed, the printed results must be stored at a particular location. To review the printed test results, the fuel dispenser identification number needs to be matched with the printed results so that the results can be retrieved from the location where the printed results are stored. Retrieving such printed test results can be very time consuming. Also, the printed results can get misfiled or lost.

Furthermore, if the results are only displayed on the fuel dispenser or the testing device, there is no way of proving to the customer that the testing ever occurred unless the customer is present for the testing of the fuel dispenser. These problems are solved by the present invention.

### SUMMARY OF THE INVENTION

The present invention, in one form thereof, is an apparatus for storing test data in a fuel dispenser. The fuel dispenser includes a nonvolatile storage means. The storage means is used for storing test data relating to the fuel dispenser. An electronic controller is used for transferring the test data to the nonvolatile storage means.

The present invention, in another form, provides a method of storing test data in a fuel dispenser. The first step is generating the test data or test data set that relates to the fuel dispenser. After the test data is generated, storing of the generated test data is completed. The test data is stored to a nonvolatile memory within the fuel dispenser for later selective review and historical documentation purposes.

An advantage of the present invention is that the test history for the fuel dispenser is contained within the fuel dispenser and service personnel that want to review the test history can review the test results by accessing the fuel dispenser memory.

Another advantage of the present invention is that the storing of the test data to the computer memory located within the fuel dispenser ensures that testing was performed on the fuel dispenser before the fuel dispenser was sent to the customer.

A further advantage of the present invention is that no outside physical storage area is needed for storing all of the paper printouts of the test results and procedures.

Yet another advantage of the present invention is that the test results are much less likely to be misfiled or lost because the test results are stored within the memory of the fuel dispenser.

### BRIEF DESCRIPTION OF THE DRAWINGS

The above-mentioned and other features and advantages of this invention, and the manner of attaining them, will become more apparent and the invention will be better understood by reference to the following description of an embodiment of the invention taken in conjunction with the accompanying drawings, wherein:

FIG. 1 is a flowchart illustrating one embodiment of the present invention; and

FIG. 2 is a diagrammatic view of one embodiment of the present invention.

Corresponding reference characters indicate corresponding parts throughout the several views. The exemplification set out herein illustrates one preferred embodiment of the invention, in one form, and such exemplification is not to be construed as limiting the scope of the invention in any manner.

### DETAILED DESCRIPTION OF THE INVENTION

The present invention, in one form, is an apparatus for storing test data in a fuel dispenser. Although the majority of this patent application describes storing test data, other types of data could be stored to the nonvolatile memory. Furthermore, the connections between the components are described as being connected using cables. Alternate means of connection can be used other than cables such as a wireless connection.

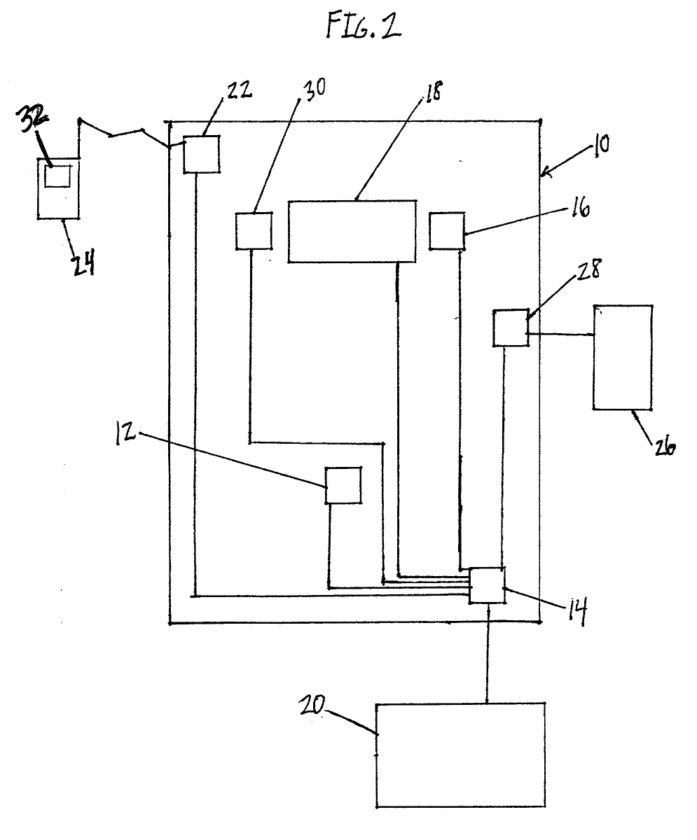

Referring now to FIG. 2 of the drawings, there is a fuel dispenser 10 having a nonvolatile storage means 12 for storing test data within fuel dispenser 10. The nonvolatile storage means 12 can be an Electronically Erasable Programmable Read Only Memory (EEPROM), Erasable Programmable Read Only Memory (EPROM), Nonvolatile Random Access Memory (NVRAM) as well as a conventional flash memory chip embedded in the dispenser control board or other main location. Other types of nonvolatile memory can be used as well such as a hard drive.

The test data that is stored in storage means 12 is, in one form, diagnostic test data. Diagnostic test data is used to ensure that the components of fuel dispenser 10 are working properly. The diagnostic testing of fuel dispenser 10 is completed using a testing device 26. Testing device 26 can be used to show any leaks from the components of fuel dispenser 10 and/or the vapor recovery system, if a vapor recovery system is utilized. The fuel dispensing components as well as the vapor recovery components can be tested using compressed air. If compressed air is used for testing, testing device 26 measures the flow rate of the compressed air needed to maintain a predetermined pressurization condition within the selected dispenser portion and based on the amount of compressed air used to maintain predetermined pressurization condition, the leak rate of that selected dispenser portion can be determined. An example is the Computerized Dispenser Tester, U.S. Pat. No. 6,070,453, and the Computerized Dispenser Tester is incorporated herein by reference.

Other types of diagnostic test data generated by testing device 26 relates to the proper functioning of the software, hardware and firmware utilized by fuel dispenser 10. Testing device 26 can ensure that the tolerances established for fuel dispenser 10 are in an acceptable range of tolerances. Also, testing device 26 can be used to ensure that the proper amount of power is being utilized by each of the components of fuel dispenser 10. Furthermore, testing device 26 can test the components of fuel dispenser 10 such as lifting the fuel dispensing nozzle from the nozzle boot, replacing the fuel dispensing nozzle in the nozzle boot, pushing each button corresponding to each grade of fuel dispensed from fuel dispenser 10 as well as activating any other switches on fuel dispenser 10.

Another form of test data stored in storage means 12 is the testing procedures utilized by testing device 26. The testing procedures describe the type of testing performed for each component of fuel dispenser 10. An example would be the number of times the fuel dispensing nozzle is lifted from the nozzle boot, the number of times the fuel dispensing nozzle is replaced in the nozzle boot and the number of times each button corresponding to each grade of fuel dispensed from fuel dispenser 10 is pressed.

Another form of test data that can be stored in storage means 12 is data relating to the inventory and transactional data relating to fuel dispenser 10. Some examples of this type of data include, but are not limited to, the number of fueling transactions, the total number of gallons dispensed from the fuel dispenser, the total amount of money spent at the fuel dispenser for a particular duration of time, the number of gallons and amount of money spent for each grade of fuel dispensed from the fuel dispenser, as well as the number of credit card transactions relating to the purchasing of fuel from the fuel dispenser.

A controller 14 is connected to memory 12 by a cable so that the test data can be transferred from controller 14 to memory 12 and controller 14 can retrieve the test data from memory 12.

Interface means 28 is connected to controller 14 using a cable. Fuel dispenser 10 has an interface means 28 for connection to testing device 26. Once the testing of fuel dispenser 10 is completed, testing device 26 is connected to interface means 28, which can be completed using a cable in one form of the invention, the connection to interface means 28 activates controller 14. Once controller 14 is activated, controller 14 retrieves the test data from testing device 26 and transfers the test data to memory 12 for storage. Each time the test data is transferred to memory 12 for storage, the test data is stored by date and/or time in a log type format which is herein after described as the test history.

In addition to transferring the test data to memory 12 for storage, controller 14 can be programmed to transfer the test data to fuel dispenser display 18 and/or to printer 16 located on fuel dispenser 10. Controller 14 can also be programmed to send the data to a remote location 20. To transfer the test data from controller 14 to remote location 20, a network connection or a dedicated line from fuel dispenser 10 to remote location 20 is established. Once the test data is transferred to remote location 20, the data can be displayed on a computer within remote location 20 as well as printed at remote location 20.

To retrieve the test data or test history from memory 12, a portable device 24, such as a personal digital assistant or laptop computer, can be used. Other portable devices can be used as well. Portable device 24 has a display 32. To retrieve the test data from memory 12, portable device 24 connects to interface means 28 using a cable. Once portable device 24 connects to interface means 28 on fuel dispenser 10, controller 14 transmits an image of a selection screen to portable device display 32 prompting the operator of portable device 24 with the option to review the test history. Upon an affirmative selection to the option, controller 14 retrieves the test history from memory 12 and transfers the test history to portable device display 32.

Fuel dispenser 10 can also have a signal receiving device 22 located on fuel dispenser 10. Signal receiving device 22 is connected to controller 14 using a cable. Portable device 24 could be used for wireless retrieval of the test history from memory 12. Upon signal receiving device 22 receiving a signal from portable device 24, controller 14 transmits an image of a selection screen to portable device display 32 prompting the operator of portable device 24 with the option to review the test history. Upon an affirmative selection to the option by the operator, controller 14 retrieves the test history from memory 12 and transfers the test history to portable device display 32.

There could also be a switch means 30, such as a button, located on fuel dispenser display 18 wherein the operator of fuel dispenser 10 could activate switch means 30 on fuel dispenser 10 to review the test data history of fuel dispenser 10 by displaying the test data history on fuel dispenser display 18. Switch means 30 is connected using a cable to controller 14. Upon activation of switch means 30, controller 14 retrieves the test data history from memory 12. Controller 14 then transmits the test data history to fuel dispenser display 18. Also, switch means 30 could be used to print the test data history once it is displayed on fuel dispenser display 18 by activating switch means 30 a second time within a predetermined amount of time.

Another use of switch means 30 is, upon activation of switch means 30, fuel dispenser display 18 will display an image prompting the operator with the option of printing the test data history, displaying the test data history or both displaying and printing the test data history. Furthermore, switch means 30 could be used only for printing the test data history to receipt printer 16 on fuel dispenser 10.

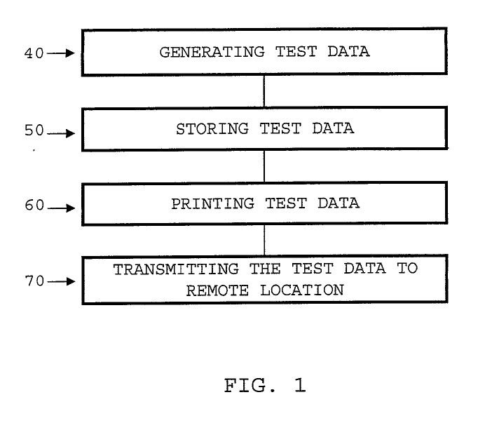

The present invention, in another form thereof, is a method of storing test data, such as diagnostic test data, in a fuel dispenser. Referring to FIG. 1 of the drawings, the first step of the method is generating (40) the test data set relating to the fuel dispenser. The test data can be generated using a testing device as discussed earlier.

Also, the test data can be generated by placing the fuel dispenser in testing mode and manually or automatically testing the fuel dispenser. The testing would be completed with the fuel dispenser display prompting the user to do such things as lift the fuel dispensing nozzle from the nozzle boot, replace the fuel dispensing nozzle in the nozzle boot, push each button corresponding to each grade of fuel dispensed from the fuel dispenser, as well as activating any other switches on the fuel dispenser. The testing of these different features allows for a predetermined amount of time for the prompted task to be completed. If the task is not completed within the predetermined amount of time, the fuel dispenser interprets the nonresponsiveness to indicate that the component is not functioning. Once the fuel dispenser has prompted each and every task, and the test data has been generated as to whether that component is functioning or not functioning, the test data is transmitted to the nonvolatile memory within the fuel dispenser for storage. The fuel dispenser can be programmed to prompt the user to test only certain components of the fuel dispenser or all the components of the fuel dispenser.

Once the test data has been generated, the next step of the method is the storing (50) the generated test data to a nonvolatile memory within the fuel dispenser. Different types of nonvolatile memory, such as EEPROM, EPROM, NVRAM or flash memory can be used. A computer hard drive could be used as well.

The nonvolatile memory, in one form of the invention, has many memory address locations within the memory. After each testing of the fuel dispenser, the test data is stored to one of the memory address locations. The first time the fuel dispenser is tested, the test data is stored in the first available memory address location. Each time the fuel dispenser is tested after the first time, the test data is stored in the next available memory address location. By storing the test data from each subsequent testing of the fuel dispenser in the next available memory address location, allows the test data to be stored chronologically by the time and/or date of the testing. Also, the testing procedure for each test performed on the fuel dispenser is stored in the memory. The memory used for storing the generated test results is a nonvolatile memory to ensure that if there is a power outage on the fuel dispenser, the stored test data will not be erased.

Printing (60) the generated test data is an option. The results after each testing of the fuel dispenser can be printed to the printer on the fuel dispenser or the test history can be retrieved from the memory and the test history of the test data can be printed to the printer on the fuel dispenser. Furthermore, the fuel dispenser can be connected to a remote location using a network connection or a dedicated line. The test data can be transmitted (70) to the remote location each time the testing occurs on the fuel dispenser or at any time the person at the remote location would like to review the test history.

While this invention has been described as having a preferred design, the present invention can be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains and which fall within the limits of the appended claims.

What is claimed is:

1. A method of storing test data in a fuel dispenser, the method comprising the steps of:
generating test data relating to a fuel dispenser; and storing the test data to a nonvolatile memory within said fuel dispenser.

2. The method in claim 1, further comprising printing the test data.

3. The method in claim 1, further comprising transmitting the test data to a remote location.

4. The method in claim 1, wherein the generated test data is diagnostic test data.

5. An apparatus for storing diagnostic test data in a fuel dispenser, comprising:
a fuel dispenser;
a nonvolatile storage means for storing test data within said fuel dispenser; and
a controller for transferring test data to said nonvolatile storage means.

6. The apparatus in claim 5, wherein said nonvolatile storage means is at least one of an EPROM, EEPROM, flash memory, hard drive and NVRAM.

7. The apparatus in claim 5, wherein said fuel dispenser further comprises a display.

8. The apparatus in claim 5, wherein said fuel dispenser further comprises a signal receiving device.

9. The apparatus in claim 5, wherein said fuel dispenser further comprises an interface means for connecting to a testing device.

10. The apparatus in claim 5, further comprising a printer for printing the test data.

11. The apparatus in claim 5, further comprising a transmitting means for transmitting the test data to a remote location.

12. The apparatus in claim 5, wherein said nonvolatile storage means is a hard drive.

13. A method of storing data in a fuel dispenser, the method comprising:
generating data relating to a fuel dispenser; and
storing the data to a nonvolatile memory within said fuel dispenser.

14. The method in claim 13, wherein the data is test data.

15. The method in claim 13, further comprising printing the data.

16. The method in claim 13, further comprising transmitting the data to a remote location.

17. The apparatus in claim 7, further comprising a switch means for activating the retrieval of the test data and displaying the test data on said display.

18. The apparatus in claim 10, further comprising a switch means for activating the retrieval of the test data and printing the test data on said printer.
